(19) United States
(12) Patent Application Publication
(10) Pub. No.: US 2010/0315226 A1
(43) Pub. Date: Dec. 16, 2010

(54) Bullet-Proof Vest Bullet Hit Detection System

(76) Inventor: Charles CHU, Banciao City (TW)

Correspondence Address: Muncy, Geissler, Olds & Lowe, PLLC, 4000 Legato Road, Suite 310, FAIRFAX, VA, 22033, US

(21) Appl. No.: 12/203,587

(22) Filed: Sep. 3, 2008

(30) Foreign Application Priority Data
Jul. 1, 2008 (TW) 097124710

(51) Int. Cl. G08B 1/08; F41H 1/02

(52) U.S. Cl. 340/539.13; 2/2.5

(57) ABSTRACT

A bullet-proof vest bullet hit detection system, including a detector fitted within a bullet-proof vest and a GPS tracker, in which the detector is able to detect circumstances of the bullet-proof vest being hit by bullets, and the detected circumstantial information is transmitted to a microprocessor. Moreover, the GPS tracker receives geographic positioning satellite coordinate signals, which are used to obtain the position of the bullet-proof vest, whereupon the position is transmitted to the microprocessor. Accordingly, position and circumstances of being hit by bullets can be transmitted to a remote server to enable notifying rescue units of the received information.

### BACKGROUND OF THE INVENTION

(a) Field of the Invention

The present invention relates to a bullet-proof vest bullet hit detection system, and more particularly to a GPS (global satellite positioning system) tracking system that transmits the circumstances of a bullet-proof vest being hit by bullets to a remote server.

(b) Description of the Prior Art

Since development of the global satellite positioning system (GPS) by the American Military, and after the government made the GPS open to public use, there has been continuous advancement in related technology and technical products, including application in various industries and at various levels, greatly increasing the standard of living of people and improving convenience in daily life, even accelerating notification of emergencies and the speed of medical rescue.

The global satellite positioning system consists of several deep space satellites, ground control stations and GPS receivers. Currently, there are 24 deep space satellites orbiting the Earth, and each of the deep space satellites equally maintain transmission of geographic position satellite coordinate signals carrying satellite orbit data and time for every type of terrestrial GPS receiver to receive. The ground control stations are responsible for tracing and controlling operation of each of the deep space satellites, as well as being responsible for correcting and maintaining each of the deep space satellites, thereby enabling normal continual transmission of each type of parameter data to the GPS receivers.

However, satellite navigators of the prior art are only able to indicate current position, route direction and neighboring buildings, and are not used to record circumstances of a bullet-proof vest being hit by bullets, resulting in the inability to effectively speed up the rescue of personnel, and thus limiting use range thereof. Hence, there is still a need for developmental design of other uses for satellite navigators.

### SUMMARY OF THE INVENTION

Hence, in light of the shortcomings of the aforementioned prior art, the inventor of the present invention, having accumulated knowhow and manufacturing experience of a diverse range of GPSs (global satellite positioning systems), attentively researched various methods to resolve the shortcomings of the prior art, which, following continuous research and improvements, culminated in the design of a completely new bullet-proof vest bullet hit detection system.

An objective of the present invention is to provide a bullet-proof vest bullet hit detection system that transmits the circumstances of the bullet-proof vest being hit by bullets to a remote server, thereby providing the ability to effectively speed up the rescue of personnel.

According to the aforementioned objective, the bullet-proof vest bullet hit detection system of the present invention comprises a detector and a signal transmission circuit fitted within a bullet-proof vest. A GPS tracker is fitted to a position adjacent to the bullet-proof vest, and the GPS tracker is provided with a GPS receiving circuit, a microprocessor, a signal transmission circuit and a signal receiving circuit. The detector of the bullet-proof vest is able to detect circumstances of the bullet-proof vest being hit by bullets, and the detected circumstantial information is transmitted to the microprocessor of the GPS tracker using the signal transmission circuit. Moreover, the GPS receiving circuit of the GPS tracker receives geographic positioning satellite coordinate signals, after which the geographic positioning satellite coordinate signals are matched with an internal prestored geographic data base to obtain the position of the bullet-proof vest, whereupon the position is transmitted to the microprocessor. When in use, the microprocessor is able to obtain the position of the bullet-proof vest from the GPS receiving circuit, and obtain circumstances regarding the bullet-proof vest being hit by bullets from the detector of the bullet-proof vest, whereupon the information obtained is transmitted to a remote server using the signal transmission circuit. Accordingly, the remote server is then able to immediately notify rescue units of the received information, and thereby speed up the rescue of personnel.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an external elevational view of a bullet-proof vest of the present invention.

FIG. 2 is a circuit block diagram of a bullet-proof vest bullet hit detection system of the present invention.

### DETAILED DESCRIPTION OF THE PREFERRED EMBODIMENTS

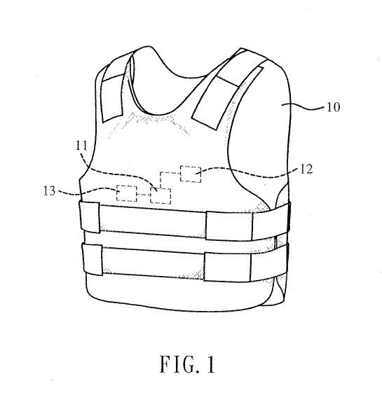

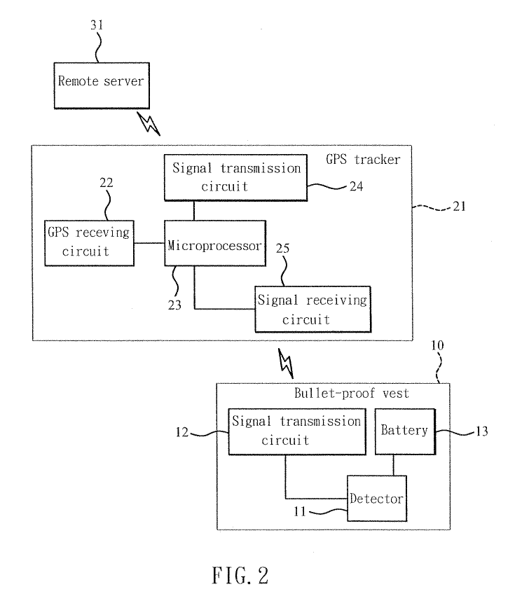

The present invention relates to a bullet-proof vest bullet hit detection system. Referring to the drawings depicted in FIGS. 1 and 2, a bullet-proof vest bullet hit detection system of the present invention comprises a detector 11 and a signal transmission circuit 12 fitted within a bullet-proof vest 10. A GPS tracker 21 is fitted to a position adjacent to the bullet-proof vest 10, and the GPS tracker 21 is provided with a GPS receiving circuit 22, a microprocessor 23, a signal transmission circuit 24 and a signal receiving circuit 25. The detector 11 of the bullet-proof vest 10 is connected to the signal transmission circuit 12, thereby enabling the detector 11 to detect circumstances of the bullet-proof vest 10 being hit by bullets, and the detected circumstantial information is transmitted to the microprocessor 23 of the GPS tracker 21 using the signal transmission circuit 12.

The microprocessor 23 of the GPS tracker 21 is separately connected to the GPS receiving circuit 22, the signal transmission circuit 24 and the signal receiving circuit 25. Moreover, the GPS receiving circuit 22 of the GPS tracker 21 receives geographic positioning satellite coordinate signals, after which the geographic positioning satellite coordinate signals are matched with an internal prestored geographic data base to obtain the position of the bullet-proof vest 10, whereupon the position is transmitted to the microprocessor 23.

According to the assembly of the aforementioned components, when in use, the microprocessor 23 is able to obtain the position of the bullet-proof vest 10 from the GPS receiving circuit 22, and obtain circumstances regarding the bullet-proof vest 10 being hit by bullets from the detector 11 of the bullet-proof vest 10, whereupon the information obtained is transmitted to a remote server 31 using the signal transmission circuit 24. Accordingly, the remote server 31 is then able to immediately notify rescue units of the received information, and thereby speed up the rescue of personnel.

Referring again to FIGS. 1 and 2, the GPS tracker 21 can also be installed on a firearm or vehicle of the user, thereby enabling use in other configurations.

Referring again to FIGS. 1 and 2, the signal transmission circuit 12 of the bullet-proof vest 10 can be connected to the signal receiving circuit 25 of the GPS tracker 21 using wired means, thereby enabling the signal transmission circuit 12 of the bullet-proof vest 10 to transmit the information detected by the detector 11 to the microprocessor 23 of the GPS tracker 21 through the signal receiving circuit 25 by means of wired transmission.

Referring again to FIGS. 1 and 2, the signal transmission circuit 12 of the bullet-proof vest 10 can be connected to the signal receiving circuit 25 of the GPS tracker 21 using wireless means, thereby enabling the signal transmission circuit 12 of the bullet-proof vest 10 to transmit the information detected by the detector 11 to the microprocessor 23 of the GPS tracker 21 through the signal receiving circuit 25 by means of wireless transmission (such as: RF (radio frequency) signals).

Referring again to FIGS. 1 and 2, a battery 13 is located within the bullet-proof vest 10. The battery 13 is connected to the detector 11, and thereby supplies electric power to the detector 11.

Referring again to FIGS. 1 and 2, the battery 13 can be a rechargeable battery, which can be connected to solar panels (not shown in the drawings) located on the bullet-proof vest 10, thereby enabling solar energy received by the solar panels to be converted into electric power and used to charge the battery 13, thus enabling the battery 13 to be kept in a fully charged state; or a battery charger can be used to charge the battery 13 and keep it in a fully charged state, thereby enabling electric power to be supplied to the detector 11 for long periods of time.

Referring again to FIGS. 1 and 2, a switch (not shown in the drawings) is fitted to a button of the bullet-proof vest 10, and one end of the switch is connected to the detector 11 of the bullet-proof vest 10, while another 13. When using the bullet-proof vest 10, the button is engaged to cause the switch to be in an ON state, thereby enabling the battery 13 to supply power to the detector 11. When the bullet-proof vest 10 is not being used, the button is disengaged to cause the switch to be in an OFF state, thereby causing the battery 13 to stop supplying power to the detector 11. Accordingly, when not in use, closing the switch realizes the function to save power.

Referring again to FIGS. 1 and 2, the GPS receiving circuit 22 can use GPS, A-GPS (Assisted Global Positioning System) or GPSone (GPS One, Global Positioning System One) satellite positioning technology, and the GPS information, including a combination of circumstances related to the bullet-proof vest 10, such as time, position, altitude and speed, is transmitted to the remote server 31.

Referring again to FIGS. 1 and 2, communication media of the signal transmission circuit 24 includes various kinds of wireless communication, such as: RF, GSM (Global System for Mobile Communications), GPRS (General Packet Radio Services), CDMA (Code Division Multiple Access), WiMAX (Worldwide Interoperability for Microwave Access) or satellite to satellite communication.

Referring again to FIGS. 1 and 2, when the GPS signal is weak, the microprocessor 23 controls the signal receiving circuit 25 to replace the GPS positioning signal with a GSM or CDMA base station positioning signal LBS (Location Based Service)/GPSone (GPS One), or a function that automatically records the last time and position is used to record the position of the bullet-proof vest 10.

Referring again to FIGS. 1 and 2, when the detector 11 has not detected that the bullet-proof vest 10 has been hit by bullets within a period of time, then together with the signal transmission circuit 12 is directed to enter a sleep mode, thereby achieving the objective of saving power.

In conclusion, the bullet-proof vest bullet hit detection system of the present invention is assuredly provided with an innovative structure not found in the prior art. Moreover, no similar products have been seen in any publication or in the market; the present invention is thus provided with undoubted originality. In addition, the present invention is provided with unique characteristics and functionality that are without comparison in the prior art. Hence, the incomparable advancement of the present invention clearly complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A bullet-proof vest bullet hit detection system, comprising:
a bullet-proof vest, a detector and a signal transmission circuit are fitted within the bullet-proof vest, and the detector of the bullet-proof vest is connected to the signal transmission circuit; the detector is able to detect circumstances of the bullet-proof vest being hit by bullets, and the detected circumstantial information is transmitted to a microprocessor of a GPS (Global Positioning System) tracker using the signal transmission circuit;
the GPS tracker is fitted to a position adjacent to the bullet-proof vest, and the GPS tracker is provided with a GPS receiving circuit, the microprocessor, a signal transmission circuit and a signal receiving circuit, the microprocessor is separately connected to the GPS receiving circuit, the signal transmission circuit and the signal receiving circuit, thereby enabling the GPS receiving circuit to receive geographic positioning satellite coordinate signals, after which the geographic positioning satellite coordinate signals are matched with an internal prestored geographic data base to obtain the position of the bullet-proof vest, whereupon the position is transmitted to the microprocessor;
whereby the microprocessor obtains the position of the bullet-proof vest by means of the GPS receiving circuit, and obtains the circumstances of the bullet-proof vest being hit by bullets through the detector of the bullet-proof vest, whereupon the circumstantial information is transmitted to a remote server using the signal transmission circuit to enable notifying rescue units and speed up the rescue of personnel.

2. The bullet-proof vest bullet hit detection system according to claim 1, wherein the GPS tracker is installed on a firearm or vehicle of the user.

3. The bullet-proof vest bullet hit detection system according to claim 1, wherein the signal transmission circuit of the bullet-proof vest is connected to the signal receiving circuit of the GPS tracker using wired means, thereby enabling the signal transmission circuit of the bullet-proof vest to transmit the information detected by the detector to the microprocessor of the GPS tracker through the signal receiving circuit by means of wired transmission.

4. The bullet-proof vest bullet hit detection system according to claim 1, wherein the signal transmission circuit of the bullet-proof vest is connected to the signal receiving circuit of the GPS tracker using wireless means, thereby enabling the signal transmission circuit of the bullet-proof vest to transmit the information detected by the detector to the microprocessor of the GPS tracker through the signal receiving circuit by means of wireless transmission.

5. The bullet-proof vest bullet hit detection system according to claim 1, wherein a battery is located within the bullet-proof vest, and the battery is connected to the detector to enable supplying electric power to the detector.

6. The bullet-proof vest bullet hit detection system according to claim 5, the battery is a rechargeable battery which is connected to solar panels located on the bullet-proof vest, thereby enabling solar energy received by the solar panels to be converted into electric power and used to charge the battery, thus enabling the battery to be kept in a fully charged state and enabling electric power to be supplied to the detector for long periods of time.

7. The bullet-proof vest bullet hit detection system according to claim 1, wherein the GPS receiving circuit uses GPS, A-GPS (Assisted Global Positioning System) or GPSone (GPS One, Global Positioning System One) satellite positioning technology, and the GPS information, including a combination of circumstances related to the bullet-proof vest, such as time, position, altitude and speed, is transmitted to the remote server.

8. The bullet-proof vest bullet hit detection system according to claim 1, wherein the communication media of the signal transmission circuit of the GPS tracker includes various kinds of wireless communication, such as: RF (radio frequency), GSM (Global System for Mobile Communications), GPRS (General Packet Radio Services), CDMA (Code Division Multiple Access), WiMAX (Worldwide Interoperability for Microwave Access) or satellite to satellite communication.

9. The bullet-proof vest bullet hit detection system according to claim 5, wherein when the detector has not detected that the bullet-proof vest has been hit by bullets within a period of time, then together with the signal transmission circuit is directed to enter a sleep mode.
